(19) United States
(12) Patent Application Publication
(10) Pub. No.: US 2007/0140282 A1
(43) Pub. Date: Jun. 21, 2007

(54) Managing on-chip queues in switched fabric networks

(76) Inventors: Sridhar Lakshmanamurthy, Sunnyvale, CA (US); Hugh M. Wilkinson III, Newton, MA (US); Jaroslaw J. Sydir, San Jose, CA (US); Paul Dormitzer, Acton, MA (US)

Correspondence Address: FISH & RICHARDSON, PC, P.O. BOX 1022, MINNEAPOLIS, MN, 55440-1022, US

(21) Appl. No.: 11/315,582

(22) Filed: Dec. 21, 2005

(51) Int. Cl. H04L 12/56

(52) U.S. Cl. 370/412

(57) ABSTRACT

Methods and apparatus, including computer program products, implementing techniques for monitoring a state of a device of a switched fabric network, the device including on-chip queues to store queue descriptors and a data buffer to store data packets, each queue descriptor having a corresponding data packet; detecting a first trigger condition to transition the device from a first state to a second state; and recovering space in the data buffer in response to the first trigger condition detecting, the recovering comprising selecting one or more of the on-chip queues for discard, and removing the data packets corresponding to queue descriptors in the selected one or more on-chip queues from the data buffer.

### BACKGROUND

This invention relates to managing on-chip queues in switched fabric networks. Advanced Switching Interconnect (ASI) is a technology based on the Peripheral Component Interconnect Express (PCIe) architecture and enables standardization of various backplanes. The Advanced Switching Interconnect Special Interest Group (ASI-SIG) is a collaborative trade organization chartered with providing a switching fabric interconnect standard, specifications of which, including the Advanced Switching Core Architecture Specification, Revision 1.1, November 2004 (available from the ASI-SIG at www.asi-sig.com), it provides to its members.

ASI utilizes a packet-based transaction layer protocol that operates over the PCIe physical and data link layers. The ASI architecture provides a number of features common to multi-host, peer-to-peer communication devices such as blade servers, clusters, storage arrays, telecom routers, and switches. These features include support for flexible topologies, packet routing, congestion management, fabric redundancy, and fail-over mechanisms.

The ASI architecture requires ASI devices to support fine grained quality of service (QoS) using a combination of status based flow control (SBFC), credit based flow control, and injection rate limits. ASI endpoint devices are also required to adhere to stringent guidelines when responding to SBFC flow control messages. In general, each ASI endpoint device has a fixed window in which to suspend or resume the transmission of packets from a given connection queue after a SBFC flow control message is received for that particular connection queue.

The connection queues are typically implemented in external memory. A scheduler of the ASI endpoint device schedules packets from the connection queues for transmission over the ASI fabric using an algorithm, such as weighted round robin (WRR), weighted fair queuing (WFQ), or round robin (RR). The scheduler uses the SBFC status information as one of the inputs to determine eligible queues. The latency to fetch the scheduled packets and inject them into a transmit pipeline of the ASI endpoint device is high due to the delay introduced by processing pipeline stages and latency to access external memory. The large latency can potentially lead to undesirable conditions if the connection queue is flow controlled. As a result, the packets need to be scheduled again to ensure that the selected packets conform to the SBFC status.

### BRIEF DESCRIPTION OF THE DRAWINGS

FIG. 1 is a block diagram of a switched fabric network.

FIG. 2A is a diagram of an ASI packet format.

FIG. 2B is a diagram of an ASI route header format.

FIG. 3 is block diagram of an ASI endpoint.

FIG. 4 is a flowchart of a buffer management process at a device of a switched fabric network

### DETAILED DESCRIPTION

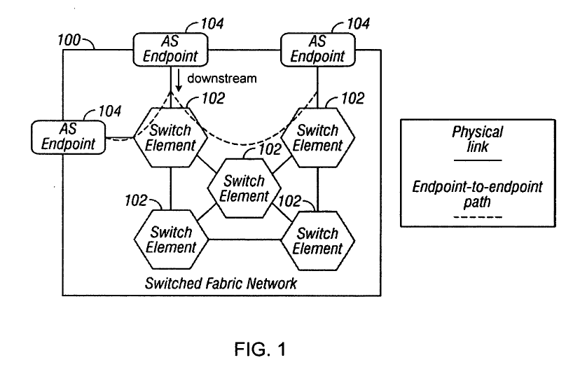

Referring to FIG. 1, an Advanced Switching Interconnect (ASI) switched fabric network 100 includes ASI devices interconnected via physical links. The ASI devices that constitute internal nodes of the network 100 are referred to as “switch elements” 102 and the ASI devices that reside at the edge of the network 100 are referred to as “endpoints” 104. Other ASI devices (not shown) may be included in the network 100. Such ASI devices can include an ASI fabric manager that is responsible for enumerating, configuring and maintaining the network 100, and ASI bridges that connect the network 100 to other communication infrastructures, e.g., PCI Express fabrics.

Each ASI device 102, 104 has an ASI interface that is part of the ASI architecture defined by the Advanced Switching Core Architecture Specification (“ASI Specification”). Each ASI switch element 102 can be implemented to support a localized congestion control mechanism referred to in the ASI Specification as “Status Based Flow Control” or “SBFC”. The SBFC mechanism provides for the optimization of traffic flow across a link between two adjacent ASI devices 102, 104, e.g., an ASI switch element 102 and its adjacent ASI endpoint 104, or between two adjacent ASI switch elements 102. By adjacent, it is meant that the two ASI devices 102, 104 are directly linked without any intervening ASI devices 104, 104.

Generally the SBFC mechanism works as follows: a downstream ASI switch element 102 transmits a SBFC flow control message to an upstream ASI endpoint 104. The SBFC flow control message provides some or all of the following status information: a Traffic Class designation, an Ordered-Only flag state, an egress output port identifier, and a requested scheduling behavior. The upstream ASI endpoint 104 uses the status information to modify its scheduling such that packets targeting a congested buffer in the downstream ASI switch element 102 are given lower priority. In particular, the upstream ASI endpoint 104 either suspends (e.g., the SBFC message is an ASI Xoff message) or resumes (e.g., the SBFC message is an ASI Xon message) transmission of packets from a connection queue, where all of the packets have the requested Ordered-Only flag state, Traffic Class field designation, and egress output port identifier. When the transmission of packets is suspended from a connection queue, that connection queue is said to be “flow controlled”.

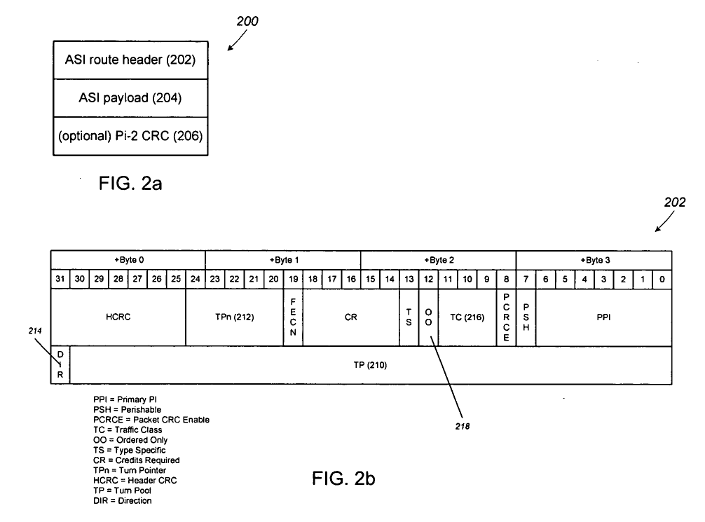

In the example scenario described below, the packets to be transmitted from the upstream ASI endpoint 104 to the downstream ASI switch element 102 include ASI Protocol Interface 2 (PI-2) packets. Referring to FIGS. 2A and 2B, each PI-2 packet 200 includes an ASI route header 202, an ASI payload 204, and optionally, a PI-2 cyclic redundancy check (CRC) 206. The ASI route header 202 includes routing information (e.g., Turn Pool 210, Turn Pointer 212, and Direction 214), Traffic Class designation 216, and deadlock avoidance information (e.g., Ordered-Only flag state 218). The ASI payload 204 contains a Protocol Data Unit (PDU), or a segment of a PDU, of a given protocol, e.g., Ethernet/ Point-to-Point Protocol (PPP), Asynchronous Transfer Mode (ATM), Packet over SONET (PoS), Common Switch Interface (CSIX), to name a few.

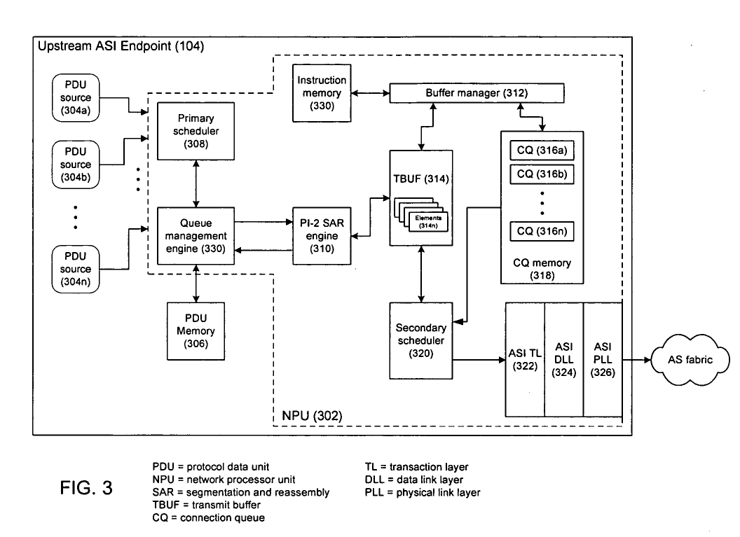

Referring to FIG. 3, the upstream ASI endpoint 104 includes a network processor (NPU) 302 that is configured to buffer PDUs received from one or more PDU sources 304a-304n, e.g., line cards, and store the PDUs in a PDU memory 306 that resides (in the illustrated example) externally to the NPU 302.

A primary scheduler 308 of the NPU 302 determines the order in which PDUs are retrieved from the PDU memory 306. The retrieved PDUs are forwarded by the NPU 302 to a PI-2 segmentation and reassembly (SAR) engine 310 of the upstream ASI endpoint.

The ASI devices 102, 104 are typically implemented to limit the maximum ASI packet size to a size that is less than the maximum ASI packet size of 2176 bytes supported by the ASI architecture. In instances in which a PDU retrieved from the PDU memory 206 has a packet size larger than the maximum payload size that may be transferred across the ASI fabric, the PDU is segmented into a number of segments. In some implementations, the segmentation is performed by microengine software in the NPU 302 prior to the individual segments being forwarded to the PI-2 SAR engine 301. In other implementations, the PDUs are forwarded to the PI-2 SAR engine 310 where the segmentation is performed.

For each received PDU (or segment of a PDU), the PI-2 SAR engine 310 forms one or more PI-2 packets by segmenting the PDU into segments whose size is smaller than the maximum supported in the network, and to each segment appending an ASI route header and optionally, computing a PI-2 CRC. A buffer manager 312 stores each PI-2 packet formed by the PI-2 SAR engine 310 into a data buffer memory 314 that is referred to in this description as a “transmit buffer” or “TBUF”. In an ideal scenario, the TBUF 314 is sized large enough to buffer all of the PI-2 packets that are in-flight across the ASI fabric. In such a scenario, the NPU 302 is ideally implemented with a TBUF 314 of a size that is greater than 512 MB for low data rates and greater than 2 MB for high data rates.

Although the ASI architecture does not place any size constraints on the TBUF 314, it is generally preferable to implement a TBUF 314 that is much smaller in size (e.g., 64 K to 256 KB) due to die size and cost constraints. In one implementation, the TBUF 314 is a random access memory that can contain up to 128 KB of data. The TBUF 314 is organized as elements 314a-314n of fixed size (elem_size), typically 32 bytes or 64 bytes per element. A given PI-2 packet of length L would be allocated mod(L/elem_size) elements 314n of the TBUF 314. An element 314n containing a PI-2 packet is designated as being “occupied”, otherwise the element 314n is designated as being “available”.

For each PI-2 packet that is stored in the TBUF 314, the buffer manager 312 also creates a corresponding queue descriptor, selects a target connection queue 316a from a number of connection queues 316a-316n residing on an on-chip memory 318 to which the queue descriptor is to be enqueued, and appends the queue descriptor to the last queue descriptor in the target connection queue 316a. The buffer manager 312 records an enqueue time for each queue descriptor as it is appended to a target connection queue 316a. The selection of the target connection queue 316a is generally based on the Traffic Class designation of the PI-2 packet corresponding to the queue descriptor to be enqueued, and its destination and path through the ASI fabric.

In order to ensure that the TBUF 314 is not over-run, the buffer manager 312 implements a buffer management scheme that dynamically determines the TBUF 314 space allocation policy. In general, the buffer management scheme is governed by the following rules: (1) if a connection queue 316a-316n is not flow controlled, PI-2 packets (corresponding to queue descriptors to be appended to that connection queue 316a-316n) are allocated space in the TBUF 314 to ensure a smooth traffic flow on that connection queue 316a-316n; (2) if a connection queue 316a-316n is flow controlled, PI-2 packets corresponding to queue descriptors to be appended to that connection queue 316a-316n are allocated space in the TBUF 314 until a certain programmable per connection queue threshold is exceeded, at which point the buffer manager 312 selects one of several options to handle the condition; and (3) packet drops and roll-back operations are triggered only when the TBUF occupancy exceeds certain thresholds to ensure that expensive roll-back operations are kept to a minimum.

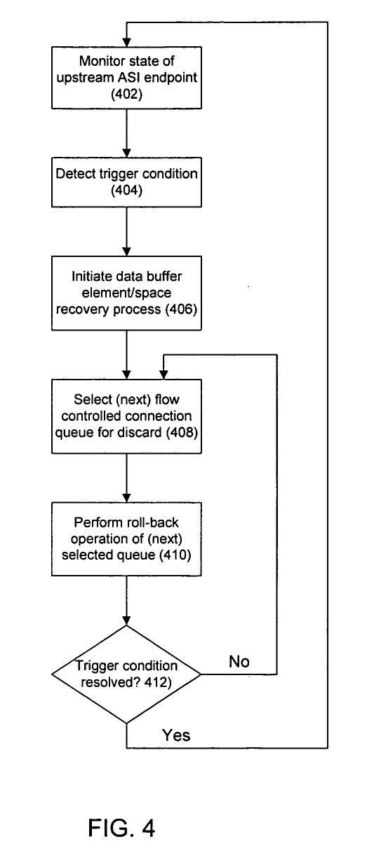

Referring to FIG. 4, as part of the buffer management scheme, the buffer manager 312 monitors (402) the state of the upstream ASI device 104. The buffer manager 314 includes one or more of the following: (1) a counter that maintains the total number of connection queues 316a-316n that are flow controlled; (2) a counter per connection queue 316a-316n that counts the total number of TBUF elements 314a-314n consumed by that connection queue 316a-316n; (3) a bit vector that indicates the flow control status for each connection queue 316a-316n; (4) a global counter that counts the total number of TBUF elements 314a-314n allocated; and (5) for each connection queue 316a-316n, a time-stamp (“head of connection queue time-stamp”) that indicates the time at which the queue descriptor at the head of the connection queue 316a-316n was enqueued. The head of connection queue time-stamp is updated when a dequeue operation is performed by the buffer manager 312 on a given connection queue 316a-316n.

The NPU 302 has a secondary scheduler 320 that schedules PI-2 packets in the TBUF 314 for transmission over the ASI fabric via an ASI transaction layer 322, an ASI data link layer 324, and an ASI physical link layer 326. In some implementations, the ASI device 104 includes a fabric interface chip that connects the NPU 302 to the ASI fabric. In a normal mode of operation, the occupancy of the TBUF 314 (i.e., the number of occupied elements 314a-314n in the TBUF) is low enough so that the rate at which elements 314a-314n are added to the TBUF 314 is at (or lower) than the rate at which elements 314a-314n are made available in the TBUF 314. That is, the secondary scheduler 320 is able to keep up with the rate at which the primary scheduler 308 fills the TBUF elements 314a-314n.

As the secondary scheduler 320 schedules each PI-2 packet for transfer over the ASI fabric, the secondary scheduler 320 sends a commit message to a queue management engine 330 of the NPU 302. Once the queue management engine 330 receives the commit message for all of the PI2 packets into which the segments of a PDU have been encapsulated, the queue management engine 330 removes the PDU data from the PDU memory 306.

Upon detection (404) of a trigger condition, the buffer manager 312 initiates (406) a process (referred to in this description as a “data buffer element recovery process”) to reclaim space in the TBUF 314 in order to alleviate the TBUF 314 occupancy concerns. Examples of such trigger conditions include: (1) the number of available TBUF elements 314a-314n falling below a certain minimum threshold; (2) the number of flow controlled queues 316a-316n exceeding a programmable threshold; and (3) the number of TBUF elements 314a-314n associated with any one flow controlled connection queue 316a-316n exceeding a programmable threshold.

Once the data buffer element recovery process is initiated, the buffer manager 312 selects (408) one or more connection queues 316a-316n for discard, and performs (410) a roll-back operation on each selected connection queue 316a-316n such that the occupied elements 314a-314n of the TBUF 314 that correspond to each selected connection queue 316a-316n are designated as being available. One implementation of the roll-back operation involves sending a rollback message (instead of a commit message) to the queue management engine 330 of the NPU 302. When the queue management engine 330 receives the rollback message for a PDU, it re-enqueues the PDU to the head of the connection queue 316a-316n and does not remove the PDU data from the PDU memory 306. In this manner, the buffer manager 312 is able to reclaim space in the TBUF 314 in which other PI-2 packets can be stored. In general, the data buffer element recovery process is governed by two rules: (1) select one or more connection queues 316a-316n to ensure that the aggregate reclaimed TBUF 314 space is sufficient so that the TBUF 314 occupancy falls below the predetermined threshold conditions; and (2) minimize the total number of roll-back operations to be performed.

Four example techniques may be implemented by the buffer manager 312 to perform the data buffer element recovery process. The specific technique used in a given scenario may depend on the source 304a-304n of the PDUs. That is, the technique applied may be line card specific to best fit the operating conditions of a particular line card configuration.

In one example, the buffer manager 312 examines each connection queue's counter and bit vector that indicates whether the connection queue is flow controlled, and identifies the flow controlled connection queue 316a-316n that has the largest number of occupied elements 314a-314n in the TBUF 314 that are allocated to that connection queue 316a-316n. The buffer manager 312 marks the identified flow controlled connection queue 316a-316n for discard, and initiates a roll-back operation for that connection queue. Occupied elements 314a-314n of the TBUF 314 allocated to that connection queue 316a-316n are designated as being available, and the buffer manager 312 re-evaluates (412) the trigger condition. If the trigger condition is not resolved (i.e., the reclaimed TBUF 314 space is insufficient), the buffer manager 312 identifies the flow controlled connection queue 316a-316n having the next largest number of occupied elements 314a-314n allocated in the TBUF 314, and repeats the process (at 408) until the trigger condition is resolved (i.e., becomes false), at which point the buffer manager returns to monitoring (402) the state of the NPU 302. By selecting flow controlled queues 316a-316n having relatively larger numbers of allocated occupied elements 314a-314n, the buffer manager 312 is able to resolve the trigger condition while minimizing the number of connection queues 316a-316n upon which roll-back operations are performed.

In another example, the buffer manager 312 examines each connections queue's head of connection queue time-stamp and bit vector that indicates whether the connection queue 316a-316n is flow controlled, and identifies the flow controlled connection queue 316a-316n having the earliest head of connection queue time-stamp. The buffer manager 312 marks the identified flow controlled connection queue 316a-316n for discard, and initiates a roll-back operation for that connection queue 316a-316n. Occupied elements 314a-314n of the TBUF 314 allocated to that connection queue 316a-316n are designated as being available, and the buffer manager 312 re-evaluates (412) the trigger condition. If the trigger condition is not resolved, the buffer manager 312 identifies the flow controlled connection queue 316a-316n having the next earliest head of connection queue time-stamp, and repeats the process (at 408) until the trigger condition is resolved. By selecting the oldest flow controlled queue 316a-316n (as reflected by the earliest head of connection queue time-stamp), the buffer manager 312 is able to resolve the trigger condition while re-designating the elements 314a-314n of the TBUF 314 that have the oldest SBFC status.

In a third example, the buffer manager 312 examines each connections queue's head of connection queue time-stamp and bit vector that indicates whether the connection queue 316a-316n is flow controlled, and identifies the flow controlled connection queue 316a-316n having the latest head of connection queue time-stamp. The buffer manager 312 marks the identified flow controlled connection queue 316a-316n for discard, and initiates a roll-back operation for that connection queue 316a-316n. Occupied elements 314a-314n of the TBUF 314 allocated to that connection queue 316a-316n are designated as being available, and the buffer manager 312 re-evaluates the trigger condition. If the trigger condition is not resolved (i.e., the reclaimed TBUF 314 space is insufficient), the buffer manager 312 identifies the flow controlled connection queue 316a-316n having the next latest head of connection queue time-stamp, and repeats the process (at 408) until the trigger condition is resolved. By selecting the newest flow controlled queue 316a-316n (as reflected by the latest head of connection queue time-stamp), the buffer manager 312 operates under the assumption that the newest flow controlled connection queue 316a-316n is unlikely to be subject to an ASI Xon message (signaling the resumption of packet transmission from that connection queue 316a-316n) in the immediate future. Accordingly, performing a roll-back operation on the newest flow controlled connection queue 316a-316n allows the buffer manager 312 to reclaim elements 314a-314n of the TBUF 314, while allowing older flow controlled queues 316a-316n to be maintained as these are more likely to be subject to ASI Xon messages. The techniques of FIG. 4 work particularly effectively in upstream ASI endpoints where the Xon and Xoff transitions occur in a round robin manner.

In a fourth example, the data buffer element recovery process is triggered when the number of flow controlled connection queues 316a-316n exceeds a certain threshold. When this occurs, the buffer manager 312 selects connection queues 316a-316n for discard based on occupancy (i.e., using each connection queue's per connection queue counter), oldest element (i.e., identifying the earliest head of connection queue time-stamped), newest element (i.e., identifying the latest head of connection queue time-stamp), or by applying a round-robin scheme. The buffer manager 312 repeatedly selects connection queues 316a-316n for discard until the number of flow controlled connection queues 316a-316n drops below the triggering threshold.

In the examples described above, the NPU 302 is implemented with on-chip connection queues 316a-316n that have shorter response times as compared to off-chip connection queues. These shorter response times enable the NPU 302 to meet the stringent response-time requirements for suspending or resuming the transmission of packets from a given connection queue 316a-316n after a SBFC flow control message is received for that particular connection queue 316a-316n. The upstream ASI endpoint is further implemented with a buffer manager 312 that dynamically manages the buffer utilization to prevent buffer over-run even if the TBUF 314 size is relatively small given die size and cost constraints.

The techniques of one embodiment of the invention can be performed by one or more programmable processors executing a computer program to perform functions of the embodiment by operating on input data and generating output. The techniques can also be performed by, and apparatus of one embodiment of the invention can be implemented as, special purpose logic circuitry, e.g., one or more FPGAs (field programmable gate arrays) and/or one or more ASICs (application-specific integrated circuits).

Processors suitable for the execution of a computer program include, by way of example, both general and special purpose microprocessors, and any one or more processors of any kind of digital computer. Generally, a processor will receive instructions and data from a memory (e.g., memory 330). The memory may include a wide variety of memory media including but not limited to volatile memory, non-volatile memory, flash, programmable variables or states, random access memory (RAM), read-only memory (ROM), flash, or other static or dynamic storage media. In one example, machine-readable instructions or content can be provided to the memory from a form of machine-accessible medium. A machine-accessible medium may represent any mechanism that provides (i.e., stores or transmits) information in a form readable by a machine (e.g., an ASIC, special function controller or processor, FPGA or other hardware device). For example, a machine-accessible medium may include: ROM; RAM; magnetic disk storage media; optical storage media; flash memory devices; electrical, optical, acoustical or other form of propagated signals (e.g., carrier waves, infrared signals, digital signals); and the like. The processor and the memory can be supplemented by, or incorporated in special purpose logic circuitry.

The invention has been described in terms of particular embodiments. Other embodiments are within the scope of the following claims. For example, the steps of an implementation of the invention can be performed in a different order and still achieve desirable results.

What is claimed is:

1. A method comprising:
monitoring a state of a device of a switched fabric network, the device comprising on-chip queues to store queue descriptors and a data buffer to store data packets, each queue descriptor having a corresponding data packet;
detecting a first trigger condition to transition the device from a first state to a second state; and
recovering space in the data buffer in response to the first trigger condition detecting, the recovering comprising selecting one or more of the on-chip queues for discard, and removing the data packets corresponding to queue descriptors in the selected one or more on-chip queues from the data buffer.

2. The method of claim 1, wherein the monitoring comprises monitoring an amount of data buffer space that is occupied by data packets.

3. The method of claim 1, wherein the monitoring comprises maintaining a counter that identifies a number of on-chip queues that are flow controlled.

4. The method of claim 1, wherein the monitoring comprises identifying, for each on-chip queue, an amount of data buffer space occupied by data packets corresponding to queue descriptors on the on-chip queue.

5. The method of claim 1, wherein the monitoring comprises maintaining a bit vector that indicates a flow control status for each on-chip queue.

6. The method of claim 1, wherein the monitoring comprises maintaining, for each on-chip queue, a time-stamp that indicates an enqueue time associated with the queue descriptor at a head of the on-chip queue.

7. The method of claim 1, wherein the first trigger condition indicates that an amount of data buffer space occupied by data packets exceeds a predetermined threshold.

8. The method of claim 1, wherein the first trigger condition indicates that a number of on-chip queues that are flow controlled exceeds a predetermined threshold.

9. The method of claim 1, wherein the first trigger condition indicates that an amount of data buffer spaced occupied by data packets corresponding to queue descriptors of an on-chip queue exceeds a predetermined threshold.

10. The method of claim 1, wherein the first trigger condition indicates that a number of on-chip queues that are flow controlled exceeds a predetermined threshold.

11. The method of claim 1, wherein the selecting comprises minimizing a number of on-chip queues selected for discard while maximizing an amount of space recovered from the data buffer.

12. The method of claim 1, wherein the selecting comprises determining which flow controlled on-chip queue is associated with data packets that occupy the largest amount of buffer space, and selecting for discard a flow controlled on-chip queue based on the determination.

13. The method of claim 1, wherein the selecting comprises determining which flow controlled on-chip queue has the oldest head queue descriptor, and selecting for discard a flow controlled on-chip queue based on the determination.

14. The method of claim 1, wherein the selecting comprises determine which flow controlled on-chip queue has the newest head queue descriptor, and selecting for discard a flow controlled on-chip queue based on the determination.

15. The method of claim 1, further comprising:
repeating the performing until a second trigger condition to transition the device from the second state to the first state is detected.

16. The method of claim 15, wherein the second trigger condition indicates that an amount of data buffer space occupied by data packets is below a predetermined threshold.

17. The method of claim 1, wherein the switched fabric network comprises an Advanced Switching Interconnect (ASI) fabric, the device comprises an ASI endpoint or an ASI switch element, and each on-chip queue comprises an ASI connection queue.

18. The method of claim 1, wherein the device comprises a network processor unit, the network processor unit including an Advanced Switching Interconnect (ASI) interface.

19. The method of claim 1, wherein the device comprises a fabric interface chip that connects to a network processor unit through a first Advanced Switching Interconnect (ASI) interface and connects to an ASI fabric through a second ASI interface.

20. The method of claim 1, wherein the device comprises a network processor unit and an Advanced Switching Interconnect (ASI) interface.

21. At a switched fabric device comprising on-chip queues and buffer elements each designated as to its availability state, a method comprising:
upon detection of a first triggering condition, recovering space in one or more of the buffer elements until a second triggering condition is detected, the recovering comprising selecting one of the on-chip queues for discard, and designating the elements allocated to the selected on-chip queue as being available.

22. The method of claim 21, wherein a buffer element designated as occupied stores a data packet.

23. A machine-accessible medium comprising content, which, when executed by a machine causes the machine to:
detect a first trigger condition to transition a switched fabric device from a first state to a second state, the device comprising on-chip queues to store queue descriptors and a data buffer to store data packets, each queue descriptor having a corresponding data packet; and
recover space in the data buffer in response to the first trigger condition detection, wherein the content, which, when executed by the machine causes the machine to recover space in the data buffer comprises content to select one or more of the on-chip queues for discard, and content to remove the data packets corresponding to queue descriptors in the selected one or more on-chip queues from the data buffer.

24. The machine-accessible medium of claim 23, further comprising content, which, when executed by the machine causes the machine to:
recover space in the data buffer until a second trigger condition to transition the device from the second state to the first state is detected.

25. The machine-accessible medium of claim 24, wherein the second trigger condition indicates that an amount of data buffer space occupied by data packets is below a predetermined threshold.

26. A switched fabric device comprising:
a processor;
on-chip queues to store queue descriptors;
a first memory to store data packets corresponding to the queue descriptors;
a second memory including buffer management software to provide instructions to the processor to:
detect a first trigger condition to transition the device from a first state to a second state; and
in response to the first trigger condition detection, perform a first memory space recovery process that comprises selecting one or more of the on-chip queues for discard, and removing the data packets corresponding to queue descriptors in the selected one or more on-chip queues from the first memory.

27. The switched fabric device of claim 26, wherein the first memory comprises a plurality of buffer elements, each buffer element being designated as available or occupied depending on whether a data packet is stored in the buffer element.

28. The switched fabric device of claim 27, wherein the buffer management software further to provide instructions to the processor to designate the buffer elements allocated to the selected one or more on-chip queues as being available.

29. The switched fabric device of claim 26, wherein the switched fabric network comprises an Advanced Switching Interconnect (ASI) fabric, the device comprises an ASI endpoint or an ASI switch element, and each on-chip queue comprises an ASI connection queue.

30. A system comprising:
switched fabric devices interconnected by links of a fabric, at least one of the switched fabric devices including:
a source of protocol data units; and
a network processor unit comprising:
a processor;
on-chip queues to store queue descriptors;
a first memory to store data packets corresponding to the queue descriptors, each data packet comprising a protocol data unit or a segment of a protocol data unit; and
a second memory including buffer management software to provide instructions to the processor to detect a first trigger condition to transition the device from a first state to a second state, and in response to the first trigger condition detection, perform a first memory space recovery process that comprises selecting one or more of the on-chip queues for discard, and removing the data packets corresponding to queue descriptors in the selected one or more on-chip queues from the first memory.

31. The system of claim 30, wherein the source of protocol data units comprises a line card.

32. The system of claim 30, wherein the fabric comprises an Advanced Switching Interconnect (ASI) fabric, the at least one switched fabric device comprises an ASI endpoint, and each on-chip queue comprises an ASI connection queue.
